(19) United States
(12) Patent Application Publication
(10) Pub. No.: US 2022/0067169 A1
(43) Pub. Date: Mar. 3, 2022

(54) METHOD AND APPARATUS FOR GENERATING SECURITY VULNERABILITY GUIDELINES

(71) Applicant: SECURE CODE WARRIOR LIMITED, Northampton (GB)

(72) Inventors: Pieter DE CREMER, Oostkamp (BE); Matias MADOU, Lichtervelde (BE); Nathan DESMET, Beernem (BE); Colin WONG, Jannali (AU)

(21) Appl. No.: 17/005,729

(22) Filed: Aug. 28, 2020

(51) Int. Cl. G06F 21/57; G06F 9/451

(52) U.S. Cl. CPC G06F 21/577; G06F 2221/033; G06F 9/451

(57) ABSTRACT

A method includes processing computer readable rule code to generate one or more guidelines, the computer readable rule code being viewable by way of a user interface. The one or more guidelines include at least one rule and one or more of a hint to correct computer readable application code if the computer readable application code is non-compliant, one or more compliance levels, a category of the at least one rule, a remediation to correct the computer readable application code, or a message indicative of a training sequence associated with the at least one rule. The method also includes causing the at least one of the hint, the one or more compliance levels, the remediation or the message to be displayed by way of the user interface and updated based on one or more changes made to the computer readable rule code.

### BACKGROUND

Software developers are continually challenged to produce computer readable code with limited errors. Errors in computer readable code often lead to programs that have potential security defects or vulnerabilities. Errors are often introduced into computer readable code due to lack of code writing experience, limited training, and/or developer oversight.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a diagram of a system for at least one of detecting and remediating security vulnerabilities in computer readable code, or generating, modifying or updating one or more guidelines for detecting and remediating security vulnerabilities in computer readable code, in accordance with one or more embodiments.

FIG. 2 is a flow chart of a method of detecting and remediating security vulnerabilities in computer readable code, in accordance with one or more embodiments.

FIG. 3 is a flow chart of a method of generating, modifying and/or updating one or more guidelines, in accordance with one or more embodiments.

FIG. 4 is a flowchart of a method of generating, modifying and/or updating one or more guidelines, in accordance with one or more embodiments.

FIG. 5 is a diagram of a user interface, in accordance with one or more embodiments.

FIG. 6 is a functional block diagram of a computer or processor-based system upon which or by which some embodiments are implemented.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation or position of a first feature over or on a second feature in the description that follows may include embodiments in which the first and second features are formed or positioned in direct contact, and may also include embodiments in which additional features may be formed or positioned between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of an apparatus or object in use or operation in addition to the orientation depicted in the figures. The apparatus may be otherwise oriented (rotated 90 degrees or at other orientations) and the spatially relative descriptors used herein may likewise be interpreted accordingly.

Errors in computer readable code often lead to programs that have potential security defects or vulnerabilities. Errors are often introduced into computer readable code due to lack of code writing experience, limited training, and/or developer oversight. For example, erroneous computer readable code may be vulnerable to one or more of SQL injections, XSS attacks, XXE injections, and sensitive data exposure, among other issues.

Computer readable code is often subjected to a scanning process to identify potential errors in the computer readable code. Such scanning processes, however, are typically performed by static analysis tools that analyze computer readable code for security defects or vulnerabilities after the code is completed and before a program is deployed, such as during the build process. But, identifying problems as the code is written would help developers identify and fix potentially problematic code fragments sooner, improving code quality, code security, development efficiency, and helping to avoid any potential compounding effects that may be caused by multiple problematic code fragments.

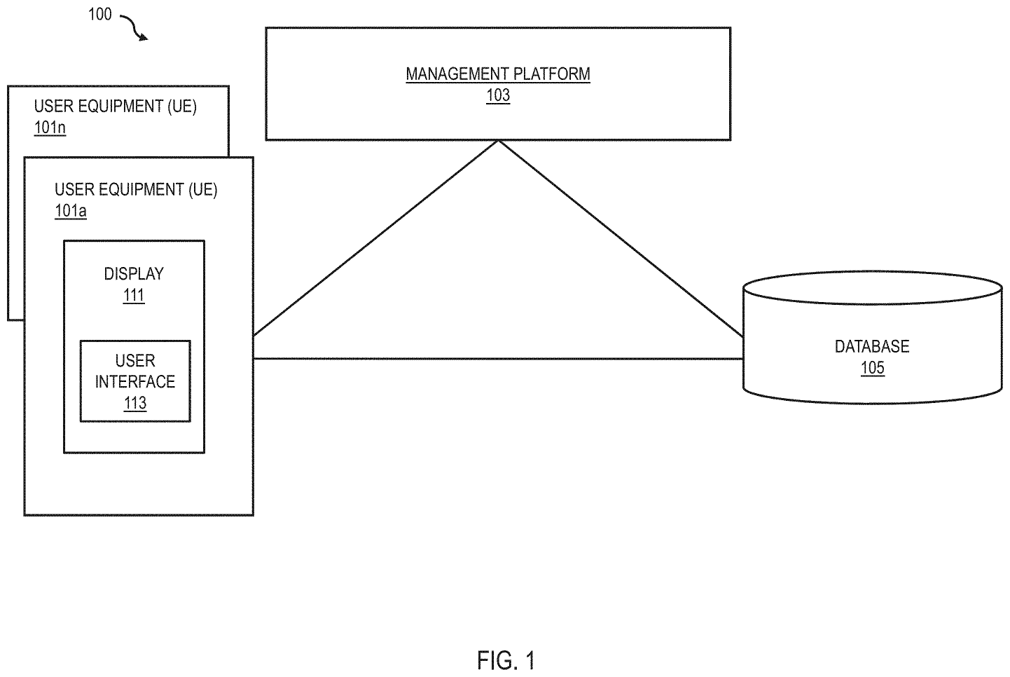

FIG. 1 is a diagram of system 100, in accordance with one or more embodiments. System 100 makes it possible to one or more of create or enforce secure coding guidelines that, when adhered to, prevent the introduction of potential vulnerabilities to developed computer readable code. For ease of discussion, computer readable code that is developed, written, and checked for potential errors, defects, vulnerabilities, flaws, etc. that could introduce potential security vulnerabilities is referred to herein as computer readable application code. However, the usage of the phrase computer readable application code should be understood to correspond to any computer code that is capable of being executed by a processor.

As shown in FIG. 1, the system 100 comprises user equipment (UE) 101a-101n (collectively referred to herein as “UE 101”) having connectivity to a management platform 103 and a database 105.

The UE 101, the management platform 103 and the database 105 are modular components of a special purpose computer system. In some embodiments, one or more of the UE 101, the management platform 103, and the database 105 are unitarily embodied in the UE 101. The UE 101, accordingly, comprises a processor by which the management platform 103 is executed. In some embodiments, one or more of the UE 101, the management platform 103 and/or the database 105 are configured to be located remotely from each other. By way of example, the UE 101, the management platform 103 and/or the database 105 communicate by wired or wireless communication connection and/or one or more networks, or combination thereof.

The UE 101 is a type of mobile terminal, fixed terminal, or portable terminal including a desktop computer, laptop computer, notebook computer, netbook computer, tablet computer, wearable circuitry, mobile handset, server, gaming console, or combination thereof. The UE 101 comprises a display 111 by which a user interface 113 is displayed. In some embodiments, the user interface 113 additionally or alternatively comprises an audio interface or an interface that interacts with a user via a haptic response.

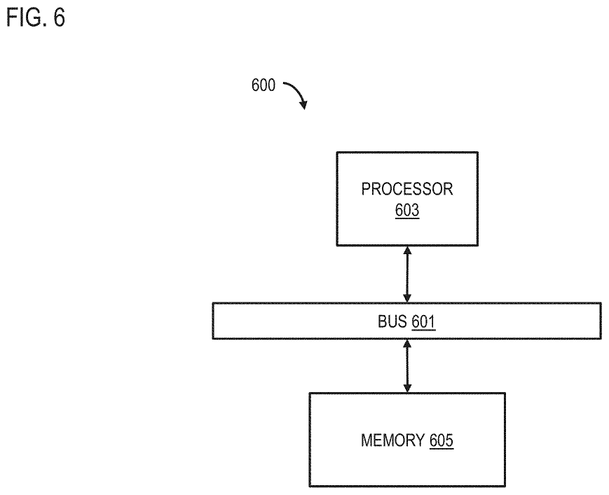

Database 105 is a memory such as a memory 605 (FIG. 6) capable of being queried or caused to store data associated with the UE 101, a user interaction with the user interface 113, data files associated with detecting and remediating vulnerabilities in computer readable application code, one or more user profiles, preset templates or guidelines for identifying and/or correcting errors in computer readable application code, data capable of being accessed by or shared with users of the system 100, and/or other suitable data associated with the use of or access to system 100.

Management platform 103 is a set of computer readable instructions that, when executed by a processor such as a processor 603 (FIG. 6), one or more of performs one or more processes, or causes one or more processes to be performed by one or more of a processor, UE 101, database 105, or some other suitable device having connectivity to management platform 103. In some embodiments, management platform 103 facilitates the connectivity between the UE 101 and database 105. In some embodiments, the management platform 103 causes information that describes one or more of the UE 101, interactions with user interface 113, or other suitable information to be stored in the database 105. In some embodiments, management platform 103 is implemented by a computer remote from UE 101. In some embodiments, management platform 103 is implemented by one or more UE 101's. In some embodiments, a portion of management platform 103 is implemented by at least one UE 101 and by one or more other UE 101's and/or one or more other computers remote from a UE 101.

In some embodiments, the management platform 103 is configured to cause an operating or behavioral status or function of one or more of the UE 101 to be queried and optionally stored in the database 105.

In some embodiments, one or more of the management platform 103 or the UE 101 is configured to query, or issue commands to determine the operating or behavioral status, a configuration, or function via one or more application programming interfaces (API's). Similarly, in some embodiments, one or more of the management platform 103 or the UE 101 is configured to change the operating or behavioral status, a configuration, or function via one or more API's.

Management platform 103 is configured to process computer readable application code to identify one or more errors in the computer readable application code. In some embodiments, the computer readable application code is generated in a development environment that is one or more of included as a part of system 100 or with which the system 100 is in communication. In some embodiments, developers that use the development environment for generating computer readable application code have a user profile associated with the development environment. In some embodiments, the user profile is stored in memory 105. In some embodiments, the user profile includes information regarding one or more training sequences completed by the developer. In some embodiments, the information regarding the one or more training sequences comprises one or more of a topic of the training sequence, a difficulty level of the training sequence, a content of the training sequence, a success rate of the training sequence, a time the training sequence was performed, a duration of time taken to complete the training sequence, a quantity of errors that occurred while performing a training sequence, a quantity of compliances that occurred while performing the training sequence, or some other suitable information indicative of a developer's level of performance while attempting to complete the training sequence. In some embodiments, management platform 103 is configured to identify a user profile associated with the development environment used to generate the computer readable application code and search a database for user profile information indicative of a training sequence performed by a user associated with the user profile.

In some embodiments, management platform 103 processes computer readable application code input into a user interface field and simultaneously viewable by way of user interface 113 including the user interface field, to determine whether the computer readable application code is in compliance with one or more guidelines. The one or more guidelines comprise at least one rule and one or more of a hint to correct the computer readable application code based on a determination that the computer readable application code is non-compliant with the at least one rule, one or more compliance levels based on at least one of a degree of non-compliance with the at least one rule or an amount of risk associated with the determination that the computer readable application code is non-compliant with the at least one rule, a category of the at least one rule, a remediation to correct the computer readable application code based on the determination that the computer readable application code is non-compliant with the at least one rule, or a message indicative of a training sequence associated with the at least one rule.

In some embodiments, the hint is a directive on how to correct the computer readable application code to bring the non-compliant computer readable application code into compliance. In some embodiments, the hint is a reminder to encode written computer readable application code that is determined to be non-compliant because the computer readable application code should have been encoded. In some embodiments, the hint is some other suitable message customized by a user to communicate how to fix a defect or identified vulnerability based on a type of vulnerability being protected against. In some embodiments, the hint is some other suitable message customized by a user to communicate how to fix a flaw based on a type of vulnerability being protected against. In some embodiments, the hint is some other suitable message customized by a user to communicate how to fix an error based on a type of vulnerability being protected against.

In some embodiments, a compliance level is an indicator of how far off the non-compliant computer readable application code is from being compliant with the at least one rule as compared to compliant computer readable application code and/or an amount of risk associated with the determination that the computer readable application code is non-compliant with the at least one rule.

In some embodiments, a category of the at least one rule is associated with a type of vulnerability that the guideline is directed toward protecting against such as SQL injection, or some other suitable type of vulnerability. In some embodiments, the category of the at least one rule is associated with a type of error that is made which results in the vulnerability that causes the computer readable application code to be non-compliant.

In some embodiments, a remediation comprises one or more of an instruction with specific code to be entered to make the computer readable application code compliant with the at least one rule, a sample code that is capable of being inserted into the computer readable application code, a sample code that is capable of replacing a non-compliant portion of the computer readable application code, a menu including multiple compliant code options for replacing the non-compliant portion of the computer readable application code, or some other suitable change to the non-compliant computer readable application code that causes the non-compliant code to be in compliance with the at least one rule.

Management platform 103 causes the at least one of the hint, the one or more compliance levels, the remediation or the message to be displayed by way of the user interface 113 based on a determination that the computer readable application code is non-compliant with the at least one rule. In some embodiments, management platform 103 is configured to aid developers by enforcing secure coding rules in real-time while the developer is writing computer readable application code. For example, while the developer is inputting computer readable application code into the user interface field.

In some embodiments, the computer readable application code is produced or written in an integrated development environment (IDE), and management platform 103 is a component of the IDE. In some embodiments, management platform 103 is an IDE plugin. In some embodiment, management platform 103 is a component of an IDE, an IDE plug-in, or a separate application capable of communicating data with an IDE or other program in which a developer is writing code to facilitate processing of computer readable code, whether that code is being processed for errors or processed for generating or modifying a guideline. In some embodiments, management platform 103 is some other suitable plug-in associated with an application or capable of communicating with a text editor, web browser, or other suitable program which a developer is able to use for writing computer readable application code. In some embodiments, the one or more guidelines comprise API-level limitations and instructions that, when adhered to, prevent the introduction of potential vulnerabilities to the computer readable application code.

In some embodiments, a hint or remediation included in the one or more guidelines describes a code transformation to transform computer readable application code that is violating the at least one rule. In some embodiments, management platform 103 extracts the erroneous computer readable application code and replaces the erroneous computer readable application code with a preset portion of computer readable application code that is in compliance with the at least one rule. In some embodiments, management platform 103 extracts the erroneous computer readable application code and replaces the erroneous computer readable application code with a placeholder, wherein a developer is directed by management platform 103 to replace the placeholder with corrected computer readable application code input by the user or input by way of a selected computer readable application code portion from two or more preset options that are in compliance with the at least one rule and provided by management platform 103 by way of user interface 113.

Management platform 103 processes one or more changes made to the computer readable application code input into the user interface field in response to the displaying of the least one of the hint, the one or more compliance levels, the remediation or the message to determine whether the one or more changes cause the computer readable application code to be in compliance with the at least one rule. Management platform 103 causes a compliance status to be displayed by way of the user interface 113 indicating whether the one or more changes made to the computer readable application code input into the user interface field cause the computer readable application code to be in compliance with the at least one rule.

In some embodiments, the compliance status is displayed based on the one or more changes made to the computer readable application code such that the compliance status is simultaneously viewable with the computer readable application code as the one or more changes are being made.

In some embodiments, management platform 103 causes the compliance status to change from a non-compliant indicator to a compliant indicator as the one or more changes to the computer readable application code are made in real-time. In some embodiments, the non-compliant indicator/compliant indicator is a binary, yes or no, indication of whether the computer readable application code is compliant or not.

In some embodiments, the compliant indicator is based on a degree of compliance with the at least one rule and the compliant indicator is at least one of one or more partially compliant level indicators or a fully compliant indicator. The one or more partially compliant level indicators are indicative of a first degree of compliance between non-compliant and fully compliant with the at least one rule, or a second degree of compliance between the first degree of compliance and fully compliant with the at least one rule.

In some embodiments, the compliance status is a text message. In some embodiments, the compliance status is a textual indication of a quantified amount of how much risk or a type of risk the non-compliant computer readable application code poses. In some embodiments, the textual indication of how much risk the non-compliant code poses is “high,” “low”, “middle,” “mid-high,” “low-mid,” or some other suitable message. In some embodiments, the compliance status is a color coded or graphical indication of how much risk or a type of risk the non-compliant code poses. In some embodiments, the compliance status is a combination of a textual indication of risk and a color coded or graphical indication of how much risk or a type of risk the non-compliant computer readable application code poses. In some embodiments, the compliance status is a color-coded highlighting of at least the one or more changes made to the computer readable application code. In some embodiments, the non-compliant indicator is a first color indicating non-compliance and the compliant indicator is a second color indicating compliance, different from the first color. In some embodiments, management platform 103 causes the compliance level to be displayed in a manner that corresponds to the compliance status of the computer readable application code after processing the computer readable application code and before any changes are made to the computer readable application code.

In some embodiments, management platform 103 causes the non-compliant computer readable application code to be displayed differently compared to a portion of the computer readable application code that is compliant with the at least one rule. The computer readable application code comprises one or more textual characters and the non-compliant computer readable application code is caused to be displayed differently by one or more differentiation modes. The different displaying of the non-compliant computer readable application code makes it possible for a user that is writing the computer readable application code to readily identify the error. The one or more differentiation modes comprise one or more of highlighting the non-compliant computer readable application code, underlining the non-compliant computer readable application code, changing a font of the non-compliant computer readable application code, changing a font size of the non-compliant computer readable application code, displaying the non-compliant computer readable application code in a bold font, displaying the non-compliant computer readable application code in an italicized font, displaying the non-compliant computer readable application code using a different color text compared to the portion of the computer readable application code that is compliant with the at least one rule, or some other suitable differentiator.

In some embodiments, if the one or more guidelines comprises the hint, the remediation, and the message, and at least one of the one or more compliance levels or the category of the at least one rule, the management platform 103 causes the hint, the remediation or the message to be displayed based on the compliance level or the category of the at least one rule.

In some embodiments, management platform 103 detects one or more of an amount of time taken to make the changes to the computer readable application code to cause the computer readable application code to be in compliance with the at least one rule, or a quantity of attempts to make the changes to the computer readable application code to cause the computer readable application code to be in compliance with the at least one rule. Management platform 103 also causes the hint, the remediation or the message to be displayed based on the amount of time or the quantity of attempts. In some embodiments, management platform 103 causes a message indicative of a training sequence for the developer to follow based on one or more of a competency level of the developer indicated in the user profile associated with the developer, the amount of time or the quantity of attempts so that the user may improve his competency with respect to the type of coding issue that management platform 103 has identified. In some embodiments, management platform 103 is configured to one or more of cause data indicative of a developer's competency level to be stored in database 105, modify the user profile associated with the developer to update the developer's competency level, or cause a message to be sent to another user of system 100 to indicate a competency status of the developer, a change in the developer's user profile, a status of a project assigned to the developer, a notification that a developer's task make be completed late or earlier than expected based on the time taken to correct non-compliant computer readable application code, quantity of attempts, a training sequence to be taken, or some other suitable quantifier or trend capable of being used to estimate a project delay or end time.

In some embodiments, system 100 makes it possible for users to create custom coding guidelines to be enforced. In some embodiments this can be done by way of user interface 113, some other user interface associated with system 100, or by way of an external program, such as a web browser, a text editor, a terminal program, or some other suitable program, imported by way of a data file, and stored in database 105. In some embodiments, one or more of the guidelines are one or more of security focused, quality focused, or have some other suitable directive. In some embodiments, system 100 makes it possible for users to create customized coding guidelines to be enforced in one or more software projects. In some embodiments, system 100 makes it possible for users, coding experts, security experts, project managers, teachers, or other users to distribute their knowledge and monitor how non-experts absorb that knowledge when producing computer readable application code. In some embodiments, system 100 facilitates the distribution of one or more guidelines gathered from multiple users in a peer-to-peer fashion.

In some embodiments, one or more of the guidelines are templates stored in database 105. In some embodiments, the templates are capable of being modified. In some embodiments, the management platform 103 is configured to facilitate one or more of generating customized guidelines, updating or modifying of customized guidelines or pre-stored templates, sharing of one or more guidelines with other users, generating or modifying guidelines based on context, or some other suitable condition.

In some embodiments, to generate the one or more guidelines, management platform 103 causes a guideline generation user interface to be displayed. In some embodiments, the guideline generation user interface is caused to be displayed based on a user input. For example, In some embodiments, guideline generation user interface is caused to be displayed based on an operation mode of management platform 103 in which computer readable application code is processed to determine whether the computer readable application code is in compliance with one or more guidelines and, based on a determination that the computer readable application code is non-compliant, the guideline generation user interface is displayed.

For ease of discussion, the guideline generation user interface has one or more user interface fields having, and/or into which a user inputs, computer readable rule code. Computer readable rule code is processed to generate the at least one rule and/or at least one of a hint to correct the computer readable application code based on a determination that computer readable application code is non-compliant with the at least one rule, one or more compliance levels based on at least one of a degree of non-compliance with the at least one rule or an amount of risk associated with the determination that the computer readable application code is non-compliant with the at least one rule, a category of the at least one rule, a remediation to correct the computer readable application code based on the determination that the computer readable application code is non-compliant with the at least one rule, or a message indicative of a training sequence associated with the at least one rule. However, the usage of the phrase computer readable rule code should be understood to correspond to any computer code that is capable of being executed by a processor.

To generate the one or more guidelines, management platform 103 processes computer readable rule code in at least one of the user interface fields. In some embodiments, the computer readable rule code is simultaneously viewable by way of user interface 113 including the user interface field while the computer readable rule code is being processed.

The one or more generated guidelines comprise the at least one rule and one or more of a hint to correct computer readable application code based on a determination that the computer readable application code is non-compliant with the at least one rule, one or more compliance levels based on at least one of a degree of non-compliance with the at least one rule or an amount of risk associated with the determination that the computer readable application code is non-compliant with the at least one rule, a category of the at least one rule, a remediation to correct the computer readable application code based on the determination that the computer readable application code is non-compliant with the at least one rule, or a message indicative of a training sequence associated with the at least one rule.

In use, management platform 103 processes the computer readable application code to determine whether the computer readable application code is in compliance with the one or more guidelines and causes the at least one of the hint, the one or more compliance levels, the remediation or the message to be displayed based on a determination that the computer readable application code is non-compliant with the at least one rule.

In some embodiments, management platform 103 additionally processes one or more changes made to the computer readable rule code in the user interface field in response to the displaying of the least one of the hint, the one or more compliance levels, the remediation or the message, and causes the at least one of the hint, the one or more compliance levels, the remediation or the message displayed to be updated based on the one or more changes made to the computer readable rule code. In some embodiments, the computer readable application code is simultaneously displayed with the computer readable rule code. The concurrent display enables a user to see how changes to the computer readable rule code affect the detection of whether the computer readable application code is non-compliant and/or an effect the changes to the computer readable rule code have on the display of the hint, the one or more compliance levels, the remediation or the message.

In some embodiments, the at least one of the hint, the one or more compliance levels, the remediation or the message displayed is updated simultaneously with the changes made to the computer readable rule code.

In some embodiments, the computer readable application code is displayed by way of the user interface 113, and the at least one of the hint, the one or more compliance levels, the remediation or the message is displayed by way of the user interface 113. In some embodiments, the user interface 113 is a first user interface, and the computer readable application code is displayed by way of a second user interface different from the first user interface 113, and the at least one of the hint, the one or more compliance levels, the remediation or the message is displayed by way of the second user interface. In some embodiments, the first user interface and the second user interface are simultaneously viewable portions of user interface 113. In some embodiments, the first user interface and the second user interface are separately viewable and/or movable portions of a graphical user interface capable of being hidden, simultaneously viewed, moved to different portions of a display, caused to appear on different displays, or manipulated in some other suitable manner. For example, in some embodiments, the simultaneous display of the computer readable rule code and the computer readable application code is done in a user interface that is a preview window to assist in generating the one or more guidelines. In some embodiments, the preview window and the user interface including the computer readable rule code are displayed side-by-side. In some embodiments, the preview window and the user interface including the computer readable rule code are displayed one over the other. In some embodiments, the preview window and the user interface including the computer readable rule code are displayed in separable or movable windows that are capable of being displayed on separate displays or in different portions of a single display.

In some embodiments, management platform 103 causes the non-compliant computer readable application code to be displayed differently compared to a portion of the computer readable application code that is compliant with the at least one rule.

The computer readable application code comprises one or more textual characters. In some embodiments, the non-compliant computer readable application code is caused to be displayed differently by one or more differentiation modes. In some embodiments, the one or more differentiation modes comprise one or more of highlighting the non-compliant computer readable application code, underlining the non-compliant computer readable application code, changing a font of the non-compliant computer readable application code, changing a font size of the non-compliant computer readable application code, displaying the non-compliant computer readable application code in a bold font, displaying the non-compliant computer readable application code in an italicized font, displaying the non-compliant computer readable application code using a different color text compared to the portion of the computer readable application code that is compliant with the at least one rule, or some other suitable distinguisher.

In some embodiments, management platform 103 is optionally configured to process one or more changes made to the computer readable application code in response to the displaying of the least one of the hint, the one or more compliance levels, the remediation or the message to determine whether the one or more changes cause the computer readable application code to be in compliance with the at least one rule, and modify the one or more guidelines based on the changes made to the computer readable application code.

In some embodiments, management platform 103 modifies the one or more guidelines based on a cursor position in the computer readable application code at a time the computer readable application code is determined to be non-compliant.

In some embodiments, management platform 103 detects one or more files open at a time the computer readable application code is processed and modifies the one or more guidelines based on the one or more files.

In some embodiments, management platform 103 causes the one or more guidelines to be stored in database 105 and causes one or more of an updated guideline or a modified guideline to replace a corresponding guideline in the database 105.

In some embodiments, management platform 103 is configured to generate, modify, or update the one or more guidelines based on a context of the computer readable application code that is written by a developer. For example, the management platform 103 processes computer readable application code in a first user interface field that is viewable by way of user interface 113 to determine whether the computer readable application code is in compliance with one or more guidelines. The user interface 113 in this example is a first user interface that displays the computer readable application code simultaneously with the processing of the computer readable application code. The one or more guidelines comprise at least one rule and one or more of a hint to correct the computer readable application code based on a determination that the computer readable application code is non-compliant with the at least one rule, one or more compliance levels based on a degree of non-compliance with the at least one rule or an amount of risk associated with the determination that the computer readable application code is non-compliant with the at least one rule, a category of the at least one rule, a remediation to correct the computer readable application code based on the determination that the computer readable application code is non-compliant with the at least one rule, or a message indicative of a training sequence associated with the at least one rule.

In some embodiments, management platform 103 also causes a second user interface to be displayed based on a determination that the computer readable application code is non-compliant with the at least one rule. In some embodiments, the second user interface is caused to be displayed by management platform 103 based on a user input. For example, if a user is reviewing the computer readable application code and recognizes that a guideline should be generated based on a potential vulnerability in the computer readable application code, or a user recognizes that a potential vulnerability is non-compliant but is not being recognized based on one or more existing guidelines, management platform 103 facilitates user interaction with the management platform to display the second user interface for guideline generation, review and/or updating. The second user interface comprises one or more second user interface fields configured to receive computer readable rule code describing at least a portion of the one or more guidelines. Management platform 103 also detects a context associated with the computer readable application code at a time the computer readable application code is determined to be non-compliant with the at least one rule and/or the management platform 103 causes the second user interface to be displayed based on the user input. Based on the detected context, management platform 103 causes at least one of the one or more second user interface fields to be populated based on the context, or the computer readable rule code included in the one or more second user interface fields to be modified based on the context, and causes at least one of the one or more guidelines to be generated or updated, if already existing, based on the one or more populated second user interface fields or the modified computer readable rule code.

In some embodiments, the context comprises one or more of non-compliant computer readable application code displayed differently compared to a portion of the computer readable application code that is compliant with the at least one rule, one or more changes made to the computer readable application code, a cursor position in the computer readable application code at the time the computer readable application code is determined to be non-compliant with the at least one rule, a task assigned to a user that is generating the computer readable application code, one or more files open at the time the computer readable application code is determined to be non-compliant with the at least one rule, or some other suitable quantifiable factor based upon which a guideline may be generated, updated or modified.

In some embodiments, to generate or update a guideline, guideline generation user interface is optionally opened from a menu accessible by way of user interface 113. In some embodiments, the guideline generation user interface is optionally accessible by way of a shortcut key combination.

In some embodiments, management platform 103 causes a live preview of the effects a coding guideline has on computer readable application code that is processed for compliance with the at least one rule. In some embodiments, the live preview is demonstrated with respect to existing computer readable application code previously written by one or more users having user profiles associated with system 100. In some embodiments, the live preview is demonstrated with respect to some other suitable pre-existing computer readable code capable of being processed by management platform 103. For example, the pre-existing computer readable code could be a compliant code that is capable of being manipulated to demonstrate a non-compliant indicator or compliant indicator, etc.

In some embodiments, the live preview is shown on predetermined computer readable application code, or the user can choose from one or more computer readable application code samples stored in database 105. In some embodiments, computer readable application code in the live preview violating the at least one rule being specified is marked. In some embodiments, the live preview includes the result of a code transformation as a remediation.

In some embodiments, one or more of the guidelines help in the correct use of a library, framework, or other manner by which code is capable of being reused. The coding guidelines can also help to adopt a new library, framework, or other manner by which code is capable of being reused. In some embodiments, management platform 103 is configured to replace an old library or framework, or create a new library or framework, based on guidelines that help in the correct use of a library, framework, or code reuse, by one or more of causing updated guidelines, new generated guidelines, or new or updated sample computer readable application code portions for reuse in computer readable application code development to be stored in database 105. In some embodiments, an old and a new library are optionally caused to be stored as different versions of a same library, or different parts of a same version of the same library.

In some embodiments, the one or more guidelines are stored in database 105, locally on the same UE 101 on which a user is working, remotely on a different UE 101, or remotely on some other suitable device having connectivity to management platform 103. In some embodiments, the one or more guidelines are stored locally by way of a path in a project the user is working on, a directory on the UE 101 on which the user is working, a directory on another storage device, or some other suitable location. In some embodiments, the one or more guidelines are stored remotely in a same git repository as the code the user is writing, a different git repository, a version control system repository, a code repository, a different remote location accessible over a network, or some other suitable location.

In some embodiments, management platform 103 causes the one or more guidelines to be shared with other users by sending the one or more guidelines as a file, an archive, or some other suitable format. In some embodiments, management platform 103 causes the one or more coding guidelines to be distributed or accessible to one or more other users by sharing location information, access links, or other suitable direction for remotely accessing the one or more guidelines stored in database 105.

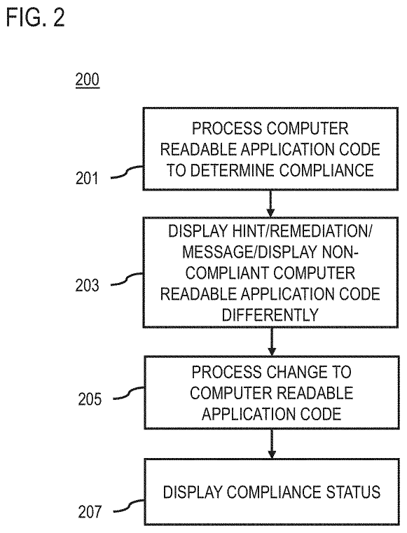

FIG. 2 is a diagram is a flow chart of a method 200 of detecting and remediating security vulnerabilities in computer readable application code, in accordance with one or more embodiments. In some embodiments, method 200 is performed by at least one processor. In some embodiments, method 200 is performed by management platform 103 (FIG. 1).

In step 201, computer readable application code is processed to determine whether the computer readable application code is in compliance with one or more guidelines. In some embodiments, prior to being processed, the computer readable application code was input into a user interface field by a user. In some embodiments, an actuation of a selectable option provided by way of a user interface including the user interface field, or a shortcut key combination, causes the computer readable application code in the user interface field to be processed. The computer readable application code included in the user interface field is simultaneously viewable by way of the user interface including the user interface field. In some embodiments, the computer readable application code is processed in real-time as the computer readable application code is entered into the user interface field.

The one or more guidelines comprise at least one rule, and one or more of a hint to correct the computer readable application code based on a determination that the computer readable application code is non-compliant with the at least one rule, one or more compliance levels based on at least one of a degree of non-compliance with the at least one rule or an amount of risk associated with the determination that the computer readable application code is non-compliant with the at least one rule, a category of the at least one rule, a remediation to correct the computer readable application code based on the determination that the computer readable application code is non-compliant with the at least one rule, or a message indicative of a training sequence associated with the at least one rule.

In step 203, the at least one of the hint, the one or more compliance levels, the remediation or the message is caused to be displayed by way of the user interface based on a determination that the computer readable application code is non-compliant with the at least one rule.

In some embodiments, the non-compliant computer readable application code is caused to be displayed differently compared to a portion of the computer readable application code that is compliant with the at least one rule. The computer readable application code comprises one or more textual characters, and the non-compliant computer readable application code is caused to be displayed differently by one or more differentiation modes. The one or more differentiation modes comprise one or more of highlighting the non-compliant computer readable application code, underlining the non-compliant computer readable application code, changing a font of the non-compliant computer readable application code, changing a font size of the non-compliant computer readable application code, displaying the non-compliant computer readable application code in a bold font, displaying the non-compliant computer readable application code in an italicized font, displaying the non-compliant computer readable application code using a different color text compared to the portion of the computer readable application code that is compliant with the at least one rule, or some other suitable differentiator.

In some embodiments, the one or more guidelines further comprises the hint, the remediation, and the message, and at least one of the one or more compliance levels or the category of the at least one rule, and the hint, the remediation or the message is also caused to be displayed based on the compliance level or the category of the at least one rule.

In some embodiments, one or more of an amount of time taken to make the changes to the computer readable application code to cause the computer readable application code to be in compliance with the at least one rule, or a quantity of attempts to make the changes to the computer readable application code to cause the computer readable application code to be in compliance with the at least one rule is detected, and the hint, the remediation or the message is caused to be displayed based on the amount of time or the quantity of attempts.

In step 205, one or more changes made to the computer readable application code input into the user interface field in response to the displaying of the least one of the hint, the one or more compliance levels, the remediation or the message are processed to determine whether the one or more changes cause the computer readable application code to be in compliance with the at least one rule.

In step 207, a compliance status is caused to be displayed by way of the user interface indicating whether the one or more changes made to the computer readable application code input into the user interface field cause the computer readable application code to be in compliance with the at least one rule. In some embodiments, the compliance status is displayed based on the one or more changes made to the computer readable application code such that the compliance status is simultaneously viewable with the computer readable application code as the one or more changes are being made. In some embodiments, the compliance status is caused to change from non-compliant indicator to a compliant indicator as the one or more changes to the computer readable application code are made in real-time. In some embodiments, the non-compliant indicator/compliant indicator is a binary, yes or no, indication of whether the computer readable application code is compliant or not.

In some embodiments, the compliant indicator is based on a degree of compliance with the at least one rule and the compliant indicator is at least one of one or more partially compliant level indicators or a fully compliant indicator, the one or more partially compliant level indicators being indicative of a first degree of compliance between non-compliant and fully compliant with the at least one rule, or a second degree of compliance between the first degree of compliance and fully compliant with the at least one rule.

In some embodiments, the compliance status is a text message. In some embodiments, the compliance status is a textual indication of a quantified amount of how much risk or a type of risk the non-compliant code poses. In some embodiments, the textual indication of how much risk the non-compliant code poses is “high,” “low”, “middle,” “mid-high,” “low-mid,” or some other suitable message. In some embodiments, the compliance status is a color coded or graphical indication of how much risk or a type of risk the non-compliant code poses. In some embodiments, the compliance status is a combination of a textual indication of risk and a color coded or graphical indication of how much risk or a type of risk the non-compliant code poses. In some embodiments, the compliance status is a color-coded highlighting of at least the one or more changes made to the computer readable application code. In some embodiments, the non-compliant indicator is a first color indicating non-compliance and the compliant indicator is a second color indicating compliance, different from the first color. In some embodiments, management platform 103 causes the compliance level to be displayed in a manner that corresponds to the compliance status of the computer readable application code after processing the computer readable application code and before any changes are made to the computer readable application code.

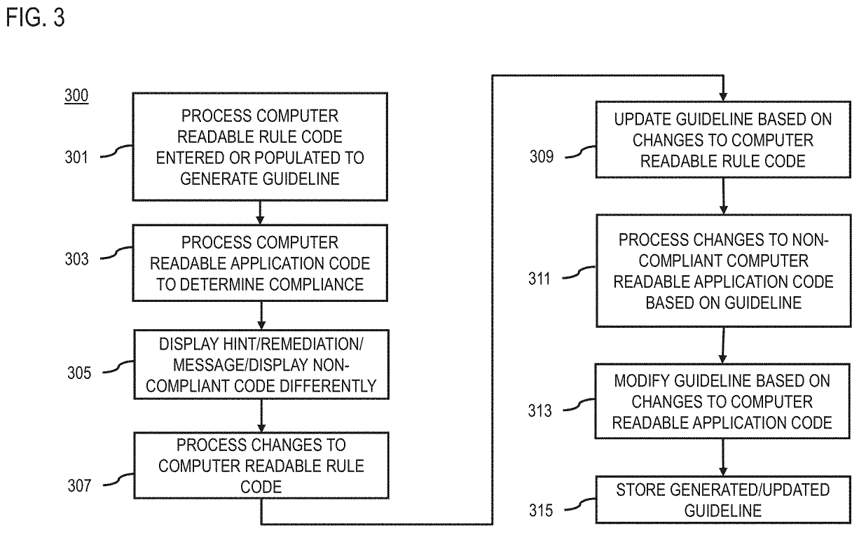

FIG. 3 is a flowchart of a method 300 of generating and/or updating one or more guidelines, in accordance with one or more embodiments. In some embodiments, method 300 is performed by at least one processor. In some embodiments, method 300 is performed by management platform 103 (FIG. 1).

In step 301, computer readable rule code is processed to generate one or more guidelines. In some embodiments, the computer readable rule code is input into a user interface field by a user for processing. In some embodiments, at least one user interface field is populated by management platform 103 based on an initiation of step 301 while a user is reviewing computer readable application code. For example, while a user is reviewing computer readable application code, if a user opens starts a guideline generation task by, for example, toggling an on-screen graphical user interface button, management platform 103 detects one or more of a cursor position in computer readable application code, one or more files detected to be open some, other suitable context at the time the user initiates step 301, and management platform 103 populates at least one user interface field based on the context at the time the user initiates step 301 to at least partially generate one or more guidelines. In some embodiments, at least one of the one or more user interface fields include pre-existing computer readable rule code.

In some embodiments, the user interface field having the computer readable rule code is simultaneously viewable by way of a user interface including the user interface field. The one or more guidelines comprise at least one rule and one or more of a hint to correct computer readable application code based on a determination that the computer readable application code is non-compliant with the at least one rule, one or more compliance levels based on at least one of a degree of non-compliance with the at least one rule or an amount of risk associated with the determination that the computer readable application code is non-compliant with the at least one rule, a category of the at least one rule, a remediation to correct the computer readable application code based on the determination that the computer readable application code is non-compliant with the at least one rule, or a message indicative of a training sequence associated with the at least one rule.

In some embodiments, method 300 proceeds directly to step 315 after generating the guideline such that method 300 ends after the generation and storing of one or more guidelines for future application to computer readable application code for compliance determination.

In some embodiments, method 300 continues or begins at step 303 for reviewing the one or more guidelines and/or updating or modifying the one or more guidelines.

In step 303, computer readable application code is processed to determine whether the computer readable application code is in compliance with the one or more guidelines.

In some embodiments, the non-compliant computer readable application code is caused to be displayed differently compared to a portion of the computer readable application code that is compliant with the at least one rule. The computer readable application code comprises one or more textual characters and the non-compliant computer readable application code is caused to be displayed differently by one or more differentiation modes. The one or more differentiation modes comprise one or more of highlighting the non-compliant computer readable application code, underlining the non-compliant computer readable application code, changing a font of the non-compliant computer readable application code, changing a font size of the non-compliant computer readable application code, displaying the non-compliant computer readable application code in a bold font, displaying the non-compliant computer readable application code in an italicized font, or displaying the non-compliant computer readable application code using a different color text compared to the portion of the computer readable application code that is compliant with the at least one rule, or some other suitable differentiator.

In step 305, the at least one of the hint, the one or more compliance levels, the remediation or the message is caused to be displayed based on a determination that the computer readable application code is non-compliant with the at least one rule. For example, in step 305, computer readable application code is processed to test and preview what the one or more generated guidelines cause to occur upon processing the computer readable application code.

In step 307, one or more changes made to the computer readable rule code input into the user interface field in response to the displaying of the least one of the hint, the one or more compliance levels, the remediation or the message are processed. For example, in step 307, computer readable application code is processed to test and preview what the changes to the computer readable rule code has on the one or more guidelines and what the modified one or more guidelines cause to occur upon processing the computer readable application code after modifying the computer readable rule code. In some embodiments, the test and preview of what the modified one or more guidelines cause to occur upon processing the computer readable application code occurs in real-time with the changes made to the computer readable rule code.

In step 309, the one or more guidelines are updated based on the one or more changes to the computer readable rule code. In some embodiments, the at least one of the hint, the one or more compliance levels, the remediation or the message displayed are caused to be updated based on the one or more changes made to the computer readable rule code.

In some embodiments, at least one of the hint, the one or more compliance levels, the remediation or the message displayed is updated simultaneously with the changes made to the computer readable rule code. In some embodiments, the computer readable application code is displayed by way of the user interface, and the at least one of the hint, the one or more compliance levels, the remediation or the message is displayed by way of the user interface. In some embodiments, the computer readable application code is displayed simultaneously with the computer readable rule code. In some embodiments, the computer readable application code is displayed simultaneously with the computer readable rule code and the at least one of the hint, the one or more compliance levels, the remediation or the message is displayed by way of the user interface.

In some embodiments, the user interface is a first user interface, and the computer readable application code is displayed by way of a second user interface different from the first user interface, and the at least one of the hint, the one or more compliance levels, the remediation or the message is displayed by way of the second user interface.

In some embodiments, method 300 proceeds directly to step 315 after updating the guideline in step 309 such that method 300 ends after updating and storing of one or more guidelines for future application to computer readable application code for compliance determination.

In some embodiments, method 300 continues or begins at step 311 for reviewing the one or more guidelines and/or updating or modifying the one or more guidelines.

In step 311, one or more changes made to the computer readable application code in response to the displaying of the least one of the hint, the one or more compliance levels, the remediation or the message are processed to determine whether the one or more changes cause the computer readable application code to be in compliance with the at least one rule. In some embodiments, step 311 is a test of a guideline to demonstrate to a user how changes in the computer readable application code are affected by the guideline. In some embodiments, changes made to the computer readable application code effect a change to the guideline. In step 313, the one or more guidelines are modified based on the changes made to the computer readable application code. In some embodiments, the one or more guidelines are modified based on a cursor position in the computer readable application code at a time the computer readable application code is determined to be non-compliant. In some embodiments, the one or more guidelines are modified based on one or more files detected to be open at a time the computer readable application code is processed. In some embodiments, one or more user interface fields associated with generating a guideline are populated based on the cursor position, files open, or some other suitable context at a time the computer readable application code is processed.

In some embodiments, management platform 103 provides an option to select how a guideline is to be generated, reviewed, updated or modified. For example, in some embodiments, management platform 103 is configured to selectively allow a user to generate a guideline by inputting computer readable rule code, detecting a context of the computer readable application code, detecting changes to the computer readable rule code and/or detecting changes to the computer readable application code.

In step 315, the one or more guidelines are caused to be stored in a database, and/or one or more of an updated guideline or a modified guideline is caused to replace a corresponding guideline in the database.

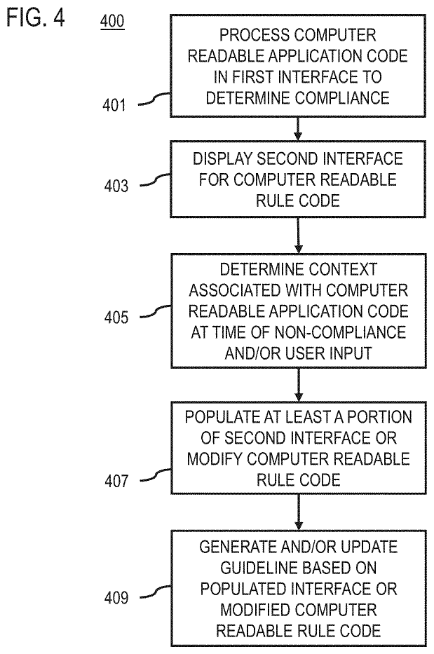

FIG. 4 is a flowchart of a method 400 of generating and/or modifying one or more guidelines, in accordance with one or more embodiments. In some embodiments, method 400 is performed by at least one processor. In some embodiments, method 400 is performed by management platform 103 (FIG. 1).

In step 401, computer readable application code is processed to determine whether the computer readable application code is in compliance with one or more guidelines. The computer readable application code is in a first user interface field, and is simultaneously viewable by way of a first user interface including the first user interface field. The one or more guidelines comprise at least one rule and one or more of a hint to correct computer readable application code based on a determination that the computer readable application code is non-compliant with the at least one rule, one or more compliance levels based on at least one of a degree of non-compliance with the at least one rule or an amount of risk associated with the determination that the computer readable application code is non-compliant with the at least one rule, a category of the at least one rule, a remediation to correct the computer readable application code based on the determination that the computer readable application code is non-compliant with the at least one rule, or a message indicative of a training sequence associated with the at least one rule.

In step 403, a second user interface is caused to be displayed. The second user interface comprises one or more second user interface fields configured to receive computer readable rule code describing at least a portion of the one or more guidelines. In some embodiments, management platform 103 causes the second user interface to be displayed based on a user input instructing management platform 103 to open the second user interface so that the user may optionally review the guideline for accuracy and/or to make changes to the guideline. For example, if a user reviewing computer readable application code for errors or testing one or more guidelines by implementing management platform 103 to perform process 400 recognizes that something may be incorrect or should be updated with respect to a guideline or a portion of the computer readable application code, management platform 103 opens the second interface to facilitate user review of one or more guidelines based on the user input. In some embodiments, the option to review a guideline based on a user input enables a user to correct a guideline that is causing management platform 103 to indicate the computer readable application code is non-compliant when the code is indeed compliant, causes management platform 103 to indicate the computer readable application code is compliant when the code is indeed non-compliant, or wishes to generate or update a guideline to capture computer readable application code that is compliant or non-compliant and that is not being recognized as either based on what the user would expect to be an applicable guideline.

In some embodiments, the second user interface is caused to be displayed based on a determination that the computer readable application code is non-compliant with the at least one rule. In some embodiments, management platform 103 facilitates an automatic guideline review mode, wherein to test or generate guidelines, the management platform 103 causes the second user interface to be displayed based on the determination that the computer readable application code is non-compliant with the at least one rule so that a user may review the guideline for accuracy and/or to make changes to the guideline.

In step 405, a context associated with the computer readable application code at a time the computer readable application code is determined to be non-compliant with the at least one rule and/or the user input is detected. In some embodiments, the context comprises one or more of non-compliant computer readable application code displayed differently compared to a portion of the computer readable application code that is compliant with the at least one rule, one or more changes made to the computer readable application code, a cursor position in the computer readable application code at the time the computer readable application code is determined to be non-compliant with the at least one rule and/or the user input is detected, or one or more files open at the time the computer readable application code is determined to be non-compliant with the at least one rule and/or the user input is detected.

In some embodiments, the contextual detection makes it possible for management platform 103 to identify an appropriate or corresponding guideline that is applicable for the portion of computer readable application code being reviewed or processed. For example, if a guideline is applicable to a particular type of code or vulnerability, management platform 103 causes the applicable guideline to be displayed by way of the second user interface. Or, if a guideline is particularly lengthy, management platform 103 causes an applicable portion of the guideline that corresponds to the context at the time of the non-compliance or user input. In some embodiments, if a user is reviewing computer readable application code and recognizes that a guideline should be causing a non-compliance determination, management platform 103 facilitates opening and viewing of an applicable guideline or portion thereof based on the context associated with the computer readable application code at the time of receiving the user input to display the second user interface.

In step 407, at least one of the one or more second user interface fields is caused to be populated based on the context, or computer readable rule code included in the one or more second user interface fields is caused to be modified based on the context. In some embodiments, populating one or more second user interface fields based on the context assists a user with generating or updating a guideline in view of the computer readable application code that is currently being reviewed which helps to improve guideline generation or update accuracy and speed with which one or more guidelines are capable of being generated and/or updated.

In step 409, at least one of the one or more guidelines is caused to be generated and/or updated based on the one or more populated second user interface fields or the modified computer readable rule code.

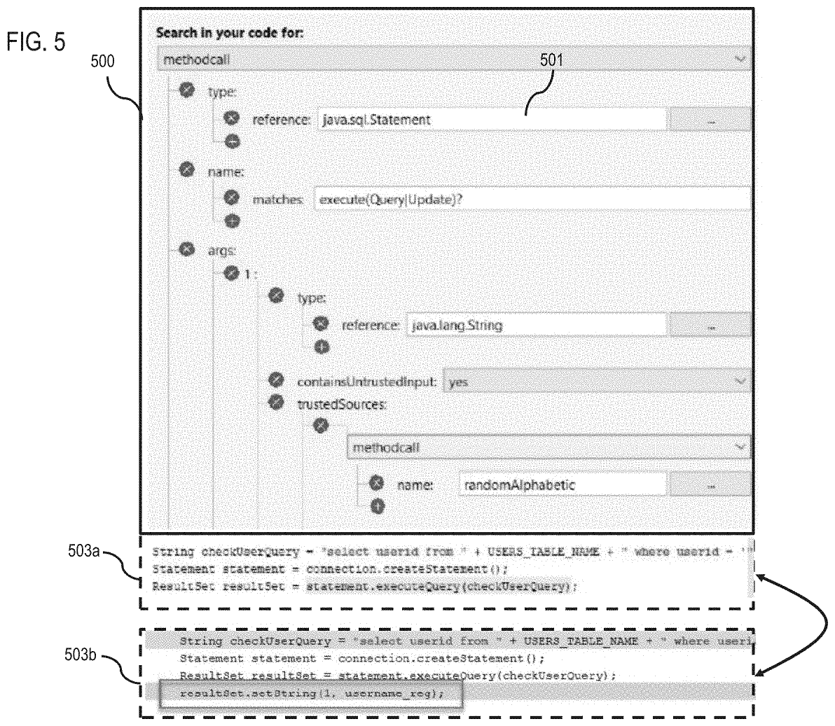

FIG. 5 is a diagram of a user interface 500, in accordance with one or more embodiments. User interface 500 is viewable by way of display 111 (FIG. 1). User interface 500 is configured to display a plurality of user interface fields 501 within which computer readable rule code and text is capable of being input or populated for processing to generate or modify a guideline. An optional preview interface 503a/503b (collectively referred to as preview interface 503) is included as a portion of user interface 500. In some embodiments, preview interface 503 is simultaneously viewable with user interface 500. In some embodiments, preview interface 503 is separable from user interface 500 and is a window that is movable within a same or to a separate display 111. In some embodiments, preview interface 503 is a separate user interface from user interface 500.

Preview interface 503 includes computer readable application code written by a user that is to be processed for compliance with the at least one rule. In some embodiments, preview interface 503 comprises one of preview interface 503a or 503b. In some embodiments, the content of preview interface 503a is replaced by the content of preview interface 503b based on an action or process initiated by management platform 103 or a user input. Preview interface 503a comprises computer readable application code that is processed to determine whether the computer readable application code in preview interface 503a is compliant with the at least one rule in user interface 500. Preview interface 503b comprises corrected computer readable application code that is processed and determined to be in, or demonstrated to be in, compliance with the at least one rule in user interface 500.

In some embodiments, user interface 500 is usable for generating one or more guidelines configured to protect computer readable application code against various types of vulnerabilities such as Structure Query Language (SQL) injections, Cross-Site Scripting (XSS) injections, Extensible Markup Language External Entity (XXE) injections, exposure of sensitive data, log forging, insecure deserialization, or other suitable concerns for which computer readable application code should be constructed to avoid attack.

As a non-limiting example, FIG. 5 demonstrates user interface 500 being used to generate a guideline to protect computer readable application code against SQL injections.

Vulnerable computer readable application code manifests itself as a bad code pattern, one that mixes trusted and untrusted data through string concatenation. When this occurs, a query interpreter cannot make the distinction between trusted and untrusted data and can therefore misinterpret the query, leading to SQL injection.

Management platform 103 (FIG. 1) uses the computer readable rule code or information input and/or populated into user interface fields 501 to generate a rule, for example, that is applied by the management platform 103 when processing computer readable application code written by a user, to identify trusted and untrusted portions of the computer readable application code. If a portion of the computer readable application code is identified as untrusted, then that computer readable application code is considered to be non-compliant with the at least one rule included in the guideline.

The rule in this example specifies that certain methodcalls (those of type java.sql.Statement and name executeQuery or executeUpdate) are not allowed, if the arguments are of the type java.lang.String and the arguments are untrusted. The rule also specifies that in this case, arguments originating from the methodcall with name randomAlphabetic can be considered trusted.

The computer readable application code in preview interface 503a is a methodcall with name executeQuery and of the right type. The computer readable application code in preview interface 503a has an argument of type java.lang.String, however, which is considered untrusted based on the rule indicated in user interface 500 according to the computer readable rule code in user interface fields 501. This causes the line of code in the computer readable application code included in preview interface 503a to be marked as non-compliant.

Management platform 103, in this example, extracts the untrusted data SQL query and uses prepared statements based on the guideline generated in accordance with the inputs in user interface fields 501 to remediate the non-compliant computer readable application code to prevent an SQL injection. Preview interface 503b shows what the changes to the computer readable application code would be made to make the computer readable application code in preview interface 503a compliant with the at least one rule.

In some embodiments, if changes were made the inputs populating the user interface field 501 while the preview interface 503 is also viewable, management platform 103 the effect of any modification made to the guideline to be shown in preview interface 503 so that a user modifying the guideline is able to see how changes made to the guideline would affect the remediation process.

In some embodiments, changes made to the computer readable application code in preview interface 503 cause changes to be made to the computer readable rule code in user interface fields 501 to change, or one or more user interface fields to be populated to modify or generate a guideline.

FIG. 6 is a functional block diagram of a computer or processor-based system 600 upon which or by which an embodiment is implemented.

Processor-based system 600 is programmed to detect and remediate security vulnerabilities in computer readable application code, as described herein, and includes, for example, bus 601, processor 603, and memory 605 components.

In some embodiments, the processor-based system is implemented as a single “system on a chip.” Processor-based system 600, or a portion thereof, constitutes a mechanism for performing one or more steps of detecting and remediating security vulnerabilities in computer readable application code and/or generating, modifying or updating one or more guidelines associated with detecting and remediating security vulnerabilities in computer readable application code.

In some embodiments, the processor-based system 600 includes a communication mechanism such as bus 601 for transferring information and/or instructions among the components of the processor-based system 600. Processor 603 is connected to the bus 601 to obtain instructions for execution and process information stored in, for example, the memory 605. In some embodiments, the processor 603 is also accompanied with one or more specialized components to perform certain processing functions and tasks such as one or more digital signal processors (DSP), or one or more application-specific integrated circuits (ASIC). A DSP typically is configured to process real-world signals (e.g., sound) in real-time independently of the processor 603. Similarly, an ASIC is configurable to perform specialized functions not easily performed by a more general purpose processor. Other specialized components to aid in performing the functions described herein optionally include one or more field programmable gate arrays (FPGA), one or more controllers, or one or more other special-purpose computer chips.

In one or more embodiments, the processor (or multiple processors) 603 performs a set of operations on information as specified by a set of instructions stored in memory 605 related to detecting and remediating security vulnerabilities in computer readable application code and/or generating, modifying or updating one or more guidelines associated with detecting and remediating security vulnerabilities in computer readable application code. The execution of the instructions causes the processor to perform specified functions.

The processor 603 and accompanying components are connected to the memory 605 via the bus 601. The memory 605 includes one or more of dynamic memory (e.g., RAM, magnetic disk, writable optical disk, etc.) and static memory (e.g., ROM, CD-ROM, etc.) for storing executable instructions that when executed perform the steps described herein to detect and remediate security vulnerabilities in computer readable application code and/or generate, modify or update one or more guidelines associated with detecting and remediating security vulnerabilities in computer readable application code. The memory 605 also stores the data associated with or generated by the execution of the steps.

In one or more embodiments, the memory 605, such as a random access memory (RAM) or any other dynamic storage device, stores information including processor instructions for detecting and remediating security vulnerabilities in computer readable application code and/or generating, modifying or updating one or more guidelines associated with detecting and remediating security vulnerabilities in computer readable application code. Dynamic memory allows information stored therein to be changed by system 100. RAM allows a unit of information stored at a location called a memory address to be stored and retrieved independently of information at neighboring addresses. The memory 605 is also used by the processor 603 to store temporary values during execution of processor instructions. In various embodiments, the memory 605 is a read only memory (ROM) or any other static storage device coupled to the bus 601 for storing static information, including instructions, that is not changed by the system 100. Some memory is composed of volatile storage that loses the information stored thereon when power is lost. In some embodiments, the memory 605 is a non-volatile (persistent) storage device, such as a magnetic disk, optical disk or flash card, for storing information, including instructions, that persists even when the system 100 is turned off or otherwise loses power.

The term “computer-readable medium” as used herein refers to any medium that participates in providing information to processor 603, including instructions for execution. Such a medium takes many forms, including, but not limited to computer-readable storage medium (e.g., non-volatile media, volatile media). Non-volatile media includes, for example, optical or magnetic disks. Volatile media include, for example, dynamic memory. Common forms of computer-readable media include, for example, a floppy disk, a flexible disk, a hard disk, a magnetic tape, another magnetic medium, a CD-ROM, CDRW, DVD, another optical medium, punch cards, paper tape, optical mark sheets, another physical medium with patterns of holes or other optically recognizable indicia, a RAM, a PROM, an EPROM, a FLASH-EPROM, an EEPROM, a flash memory, another memory chip or cartridge, or another medium from which a computer can read. The term computer-readable storage medium is used herein to refer to a computer-readable medium.

An aspect of this description relates to a method comprising processing, by a processor, computer readable rule code in a user interface field and simultaneously viewable by way of a user interface including the user interface field, to generate one or more guidelines. The one or more guidelines comprise at least one rule and one or more of a hint to correct computer readable application code based on a determination that the computer readable application code is non-compliant with the at least one rule, one or more compliance levels based on at least one of a degree of non-compliance with the at least one rule or an amount of risk associated with the determination that the computer readable application code is non-compliant with the at least one rule, a category of the at least one rule, a remediation to correct the computer readable application code based on the determination that the computer readable application code is non-compliant with the at least one rule, or a message indicative of a training sequence associated with the at least one rule. The method also comprises processing the computer readable application code to determine whether the computer readable application code is in compliance with the one or more guidelines. The method further comprises causing the at least one of the hint, the one or more compliance levels, the remediation or the message to be displayed based on a determination that the computer readable application code is non-compliant with the at least one rule.

Another aspect of this description is directed to an apparatus comprising at least one processor and a memory having computer readable instructions stored thereon that, when executed by the at least one processor, cause the apparatus to process computer readable code in a user interface field and simultaneously viewable by way of a user interface including the user interface field, to generate one or more guidelines. The or more guidelines comprise at least one rule and one or more of a hint to correct the computer readable code based on a determination that the computer readable code is non-compliant with the at least one rule, one or more compliance levels based on at least one of a degree of non-compliance with the at least one rule or an amount of risk associated with the determination that the computer readable application code is non-compliant with the at least one rule, a category of the at least one rule, a remediation to correct the computer readable code based on the determination that the computer readable code is non-compliant with the at least one rule, or a message indicative of a training sequence associated with the at least one rule. The apparatus is also caused to process the computer readable application code to determine whether the computer readable application code is in compliance with the one or more guidelines. The apparatus is further caused to cause the at least one of the hint, the one or more compliance levels, the remediation or the message to be displayed based on a determination that the computer readable code is non-compliant with the at least one rule.

Another aspect of this description is related to a method comprising causing a first user interface to be displayed. The first user interface includes a first user interface field. The first user interface has computer readable application code in the first user interface field. The method also comprises causing a second user interface to be displayed. The second user interface comprises one or more second user interface fields configured to receive computer readable rule code describing at least a portion of one or more guidelines. The one or more guidelines comprise at least one rule and one or more of a hint to correct the computer readable code based on a determination that the computer readable code is non-compliant with the at least one rule, one or more compliance levels based on at least one of a degree of non-compliance with the at least one rule or an amount of risk associated with the determination that the computer readable application code is non-compliant with the at least one rule, a category of the at least one rule, a remediation to correct the computer readable code based on the determination that the computer readable code is non-compliant with the at least one rule, or a message indicative of a training sequence associated with the at least one rule. The method additionally comprises detecting a context associated with the computer readable application code at a time the second user interface is caused to be displayed. The method also comprises causing, by a processor, at least one of at least one of the one or more second user interface fields to be populated with the computer readable rule code based on the context The method further comprises generating at least one of the one or more guidelines based, at least in part, on the computer readable rule code populated into the at least one of the one or more second user interface fields.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method, comprising:
processing, by a processor, computer readable rule code in a user interface field and simultaneously viewable by way of a user interface including the user interface field, to generate one or more guidelines, the one or more guidelines comprising:
at least one rule; and
one or more of:
a hint to correct computer readable application code based on a determination that the computer readable application code is non-compliant with the at least one rule;
one or more compliance levels based on at least one of a degree of non-compliance with the at least one rule or an amount of risk associated with the determination that the computer readable application code is non-compliant with the at least one rule;
a category of the at least one rule;
a remediation to correct the computer readable application code based on the determination that the computer readable application code is non-compliant with the at least one rule; or
a message indicative of a training sequence associated with the at least one rule;
processing the computer readable application code to determine whether the computer readable application code is in compliance with the one or more guidelines; and
causing the at least one of the hint, the one or more compliance levels, the remediation or the message to be displayed based on a determination that the computer readable application code is non-compliant with the at least one rule.

2. The method of claim 1, further comprising:
processing one or more changes made to the computer readable rule code in the user interface field in response to the displaying of the least one of the hint, the one or more compliance levels, the remediation or the message; and
causing the at least one of the hint, the one or more compliance levels, the remediation or the message displayed to be updated based on the one or more changes made to the computer readable rule code.

3. The method of claim 2, wherein the at least one of the hint, the one or more compliance levels, the remediation or the message displayed is updated simultaneously with the changes made to the computer readable rule code.

4. The method of claim 3, wherein the computer readable application code is displayed by way of the user interface simultaneously with the computer readable rule code, and the at least one of the hint, the one or more compliance levels, the remediation or the message is displayed by way of the user interface.

5. The method of claim 3, wherein the user interface is a first user interface, the computer readable application code is displayed by way of a second user interface different from the first user interface, and the at least one of the hint, the one or more compliance levels, the remediation or the message is displayed by way of the second user interface.

6. The method of claim 1, further comprising:
causing the non-compliant computer readable application code to be displayed differently compared to a portion of the computer readable application code that is compliant with the at least one rule.

7. The method of claim 1, further comprising:
processing one or more changes made to the computer readable application code in response to the displaying of the least one of the hint, the one or more compliance levels, the remediation or the message to determine whether the one or more changes cause the computer readable code to be in compliance with the at least one rule; and
modifying the one or more guidelines based on the changes made to the computer readable application code.

8. The method of claim 1, further comprising:
detecting a cursor position in the computer readable application code; and
modifying the one or more guidelines based on the cursor position in the computer readable application code.

9. The method of claim 1, further comprising:
detecting one or more files open at a time the computer readable application code is processed; and
modifying the one or more guidelines based on the one or more files.

10. An apparatus, comprising:
at least one processor; and
a memory having computer readable instructions stored thereon that, when executed by the at least one processor, cause the apparatus to:
process computer readable rule code in a user interface field and simultaneously viewable by way of a user interface including the user interface field, to generate one or more guidelines, the one or more guidelines comprising:
at least one rule; and
one or more of:
a hint to correct computer readable application code based on a determination that the computer readable application code is non-compliant with the at least one rule;
one or more compliance levels based on a degree of non-compliance with the at least one rule or an amount of risk associated with the determination that the computer readable application code is non-compliant with the at least one rule;
a category of the at least one rule;
a remediation to correct the computer readable application code based on the determination that the computer readable application code is non-compliant with the at least one rule; or
a message indicative of a training sequence associated with the at least one rule;
process the computer readable application code to determine whether the computer readable application code is in compliance with the one or more guidelines; and
cause the at least one of the hint, the one or more compliance levels, the remediation or the message to be displayed based on a determination that the computer readable application code is non-compliant with the at least one rule.

11. The apparatus of claim 10, wherein the apparatus is further caused to:
process one or more changes made to the computer readable rule code in the user interface field in response to the displaying of the least one of the hint, the one or more compliance levels, the remediation or the message; and
cause the at least one of the hint, the one or more compliance levels, the remediation or the message displayed to be updated based on the one or more changes made to the computer readable rule code.

12. The apparatus of claim 11, wherein the at least one of the hint, the one or more compliance levels, the remediation or the message displayed is updated simultaneously with the changes made to the computer readable rule code.

13. The apparatus of claim 12, wherein the computer readable application code is displayed by way of the user interface simultaneously with the computer readable rule code, and the at least one of the hint, the one or more compliance levels, the remediation or the message is displayed by way of the user interface.

14. The apparatus of claim 12, wherein the user interface is a first user interface, the computer readable application code is displayed by way of a second user interface different from the first user interface, and the at least one of the hint, the one or more compliance levels, the remediation or the message is displayed by way of the second user interface.

15. The apparatus of claim 10, wherein the apparatus is further caused to: cause the non-compliant computer readable application code to be displayed differently compared to a portion of the computer readable application code that is compliant with the at least one rule.

16. The apparatus of claim 10, wherein the apparatus is further caused to:
process one or more changes made to the computer readable application code in response to the displaying of the least one of the hint, the one or more compliance levels, the remediation or the message to determine whether the one or more changes cause the computer readable code to be in compliance with the at least one rule; and
modify the one or more guidelines based on the changes made to the computer readable application code.

17. The apparatus of claim 11, wherein the apparatus is further caused to:
detect a cursor position in the computer readable application code; and
modify the one or more guidelines based on the cursor position in the computer readable application code.

18. The apparatus of claim 11, wherein the apparatus is further caused to:
detect one or more files open at a time the computer readable application code is processed; and
modify the one or more guidelines based on the one or more files.

19. A method, comprising:
causing a first user interface to be displayed, the first user interface including a first user interface field, the first user interface having computer readable application code in the first user interface field;
causing a second user interface to be displayed, the second user interface comprising one or more second user interface fields configured to receive computer readable rule code describing at least a portion of one or more guidelines, the one or more guidelines comprising:
at least one rule; and
one or more of:
a hint to correct computer readable application code based on a determination that the computer readable application code is non-compliant with the at least one rule;
one or more compliance levels based on a degree of non-compliance with the at least one rule or an amount of risk associated with the determination that the computer readable application code is non-compliant with the at least one rule;
a category of the at least one rule;
a remediation to correct the computer readable application code based on the determination that the computer readable application code is non-compliant with the at least one rule; or
a message indicative of a training sequence associated with the at least one rule;
detecting a context associated with the computer readable application code at a time the second user interface is caused to be displayed;
causing, by a processor, at least one of:
at least one of the one or more second user interface fields to be populated with the computer readable rule code based on the context; and
generating at least one of the one or more guidelines based, at least in part, on the computer readable rule code populated into the at least one of the one or more second user interface fields.

20. The method of claim 19, wherein the context comprises one or more of a cursor position in the computer readable application code at the time the second user interface is displayed, or one or more files open at the time the second user interface is displayed.
